(19) United States
(12) Patent Application Publication
(10) Pub. No.: US 2019/0217411 A1
(43) Pub. Date: Jul. 18, 2019

(54) METHOD FOR REPAIRING MAGNESIUM CASTINGS

(71) Applicant: PRATT & WHITNEY CANADA CORP., Longueuil (CA)

(72) Inventors: Pierre VERRIER, Ste-Julie (CA); Theo OUELLET, Trois-Rivières (CA)

(21) Appl. No.: 15/958,191

(22) Filed: Apr. 20, 2018

Related U.S. Application Data
(60) Provisional application No. 62/617,063, filed on Jan. 12, 2018.

(51) Int. Cl. B23K 9/00; B23K 9/095; B23K 9/173; B23K 9/10

(52) U.S. Cl. CPC B23K 9/0026; B23K 9/0953; B23K 2203/15; B23K 9/1087; B23K 9/173

(57) ABSTRACT

A method for repairing a cast component made of a magnesium-based material is disclosed. The method comprises receiving the cast component made of the magnesium-based material and adding repair material to the cast component using cold metal transfer (CMT) welding.

### TECHNICAL FIELD

The disclosure relates generally to repairing components made from magnesium-based materials.

### BACKGROUND

Magnesium alloys are light structural materials that can be used in complicated castings such as housings or cases for aircraft and aircraft engines. Magnesium alloys can have a good resistance to corrosion but corrosion can occur in some environmental/operating conditions. For some complicated and relatively expensive components made from magnesium alloys, it can be desirable to repair such parts that have been damaged due to corrosion or other causes instead of replacing such components.

### SUMMARY

In one aspect, the disclosure describes a method for repairing a cast component made of a magnesium-based material. The method comprises:

receiving the cast component made of the magnesium-based material; and

adding repair material to the cast component using cold metal transfer (CMT) welding.

The magnesium-based material of the cast component may be AMS 4439 magnesium alloy.

The repair material may be AMS 4439 magnesium alloy.

Using CMT welding may comprise using a wire made of AMS 4439 magnesium alloy as a source of repair material.

Adding repair material to the cast component may comprise making a plurality of passes on the cast component and using different CMT welding process parameters for two consecutive passes.

Adding repair material to the cast component may comprise making a plurality of passes on the cast component and using a different CMT welding process parameter for each pass.

Adding repair material to the cast component may comprise making a plurality of passes on the cast component and reducing a heat input rate into the cast component by CMT welding from one pass to a subsequent pass.

The method may comprise adding repair material to a region of the cast component using CMT welding and using more than two different CMT welding process parameters while adding repair material to the region. The region may be annular.

The cast component may be an air inlet case of a gas turbine engine.

The method may comprise removing material from a region of the cast component before adding repair material to the same region of the cast component.

The method may comprise removing repair material from the region to finish the region after adding the repair material to the region.

The method may comprise adding repair material to the cast component using pulsed metal inert gas (MIG) welding.

The repair material may be AMS 4439 magnesium alloy.

Using CMT welding may comprise using a wire made of AMS 4439 magnesium alloy as a source of repair material.

The region may be annular.

Adding repair material to the cast component may comprise making a plurality of passes in the region of the cast component and using different CMT welding process parameters for two consecutive passes.

The region may include a mating surface for interfacing with another component.

The cast component may be an air inlet case of a gas turbine engine.

The method may comprise using an oscillatory movement between a welding torch and the cast component transverse to a general relative direction of travel to produce a weaving pattern during the addition of repair material.

The method may comprise adding repair material to the cast component using pulsed MIG welding and then adding repair material to the cast component using CMT welding.

Embodiments can include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a schematic representation of a welding system shown in the process of repairing a magnesium casting;

FIG. 2 is a perspective view of part of an exemplary magnesium casting to be repaired;

FIG. 3 is perspective view of part of the magnesium casting of FIG. 2 after the addition of repair material to the magnesium casting using the welding system of FIG. 1;

FIG. 4 is perspective view of part of the magnesium casting of FIG. 2 after finishing the repair material;

FIG. 5 is a table of exemplary process parameters for repairing the magnesium casting using CMT welding;

FIG. 6 is a table of exemplary process parameters for repairing the magnesium casting using pulsed MIG welding; and

FIG. 7 is another table of exemplary process parameters for repairing the magnesium casting using CMT and pulsed MIG welding.

### DETAILED DESCRIPTION

The following description relates to a method for repairing cast magnesium components using cold metal transfer (CMT) welding. The method disclosed herein can be used to repair castings made from a magnesium alloy of the type Aerospace Materials Specification (AMS) 4439 (also referred as “ZE41A”) for example. AMS 4439 is a well proven magnesium casting alloy containing zinc, rare earths and zirconium. In the artificially aged condition referred as “ZE41A-T5”, this medium strength magnesium alloy is ideal for high integrity castings operating at ambient temperatures or up to 300° F. This versatile magnesium alloy is used in aerospace, automotive, military and electronic applications. For example, AMS 4439 castings are used in applications including helicopter gearboxes, automobile components, video cameras, military equipment, computer parts, aircraft components and aircraft engines for example.

The method disclosed herein can be used to repair a cast (e.g., rear) air inlet case for a gas turbine engine where the air inlet case is made of AMS 4439. For example, the method disclosed herein can be used to refurbish a corroded or otherwise damaged region of such air inlet case. Due to the relatively high cost of manufacturing such air inlet cases, it can be desirable to repair such components to extend their useful lives. It is understood that the method disclosed herein can also be used for welding or repairing other types of magnesium castings.

One repair method that was attempted to refurbish a corroded region of a casting made from a magnesium alloy includes the use of TIG (tungsten inert gas) welding but it was found that the TIG welding approach caused deformation of the casting and was time consuming because welding defects had to be fixed/touched-up as required. In some situations, the use of CMT welding as described herein was found to produce a good quality build-up of repair material suitable for refurbishing corroded/damaged regions of the magnesium casting in relatively short time compared to using TIG welding. CMT welding can allow metal deposition with relatively low heat input compared to other processes such as TIG welding so that deformation of the magnesium casting can be reduced.

CMT welding is a type of gas metal arc welding and works by reducing the weld current and retracting the weld wire when detecting a short circuit. This can result in a drop-by-drop deposit of weld material. CMT welding provides a controlled method of material deposition and relatively low thermal input by using wire feed system coupled to high-speed digital control. The wire feed rate and the cycle arcing phase are controlled to melt both the base material and a drop of filler wire. CMT welding uses relatively low current at the point of short circuit which corresponds to relatively low heat input.

In some embodiments, the method disclosed herein can also include the use of pulsed MIG (metal inert gas) welding. Pulsed MIG welding is a non-contact metal transfer method between the electrode and the weld puddle where at no time does the electrode ever touch the puddle. This can be accomplished through high-speed manipulation of the electrical output of the welding machine. The pulsed MIG process works by forming one droplet of molten metal at the end of the electrode per pulse. Then, current is added to push that droplet across the arc and into the puddle. The transfer of these droplets occurs through the arc, one droplet per pulse.

Pulsed MIG welding is generally a spatterless process that can run at a relatively low heat input. In some situations pulsed MIG welding may provide a higher heat input and better penetration than a comparable CMT welding process. Accordingly, it may be desirable in some repair situations to add repair material using pulsed MIG welding in one or more regions (or portion thereof) of the casting and to add repair material using CMT in one or more other regions (or portion thereof) of the casting depending on factors such as the surface finish, geometry and temperature of the casting for example.

Aspects of various embodiments are described through reference to the drawings.

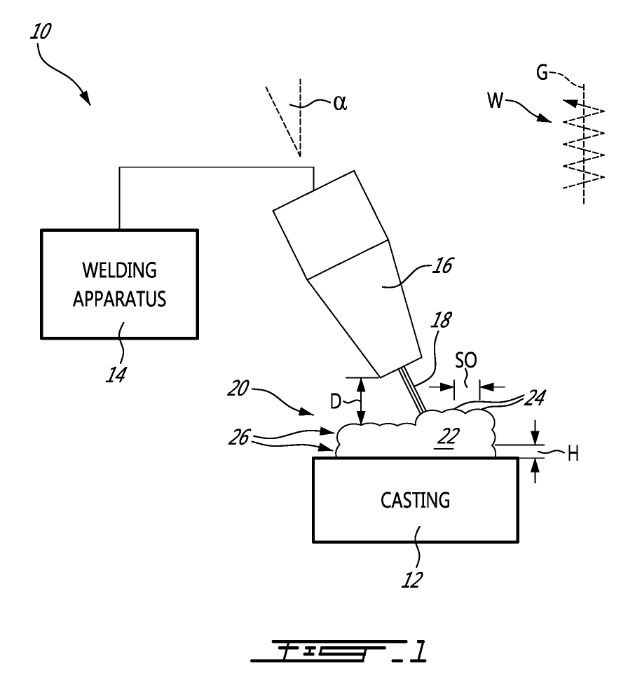

FIG. 1 is a schematic representation of a welding system 10 in the process of repairing (e.g., using CMT and/or pulsed MIG) a magnesium casting 12. Welding system 10 may include welding apparatus 14 and welding torch 16 operatively connected to apparatus 14. In one embodiment, welding system 10 comprises or is part of a commercial system known as “TransPuls Synergic 4000” sold under the trade name “FRONIUS”. Welding system 10 may also comprise a remote control unit such as the “RCU 5000” also sold under the trade name “FRONIUS”. It is understood that other types of welding systems may also be suitable for the method disclosed herein. In some embodiments, welding system 10 or part(s) thereof may be mounted to a robotic arm or other (e.g., computer numerical control) motion system suitable to control the movement of welding torch 16 relative to casting 12. Alternatively or in addition, casting 12 may be mounted to a robotic arm or other (e.g., computer numerical control) motion system suitable to control the movement of casting 12 relative to welding torch 16. In various embodiments, welding system 10 may be suitable for conducting CMT welding and/or pulsed MIG welding.

System 10 may be configured to feed wire 18 as filler repair material to be added to casting 12 for refurbishing. System 10 may be configured to control the feed of wire 18 according to suitable CMT and/or pulsed MIG welding methods as explained above. In some embodiments, wire 18 may be made of AMS 4439 magnesium alloy.

Casting 12 may comprise region 20 to be repaired. In some embodiments, region 20 may comprise a mating surface for interfacing with another component. In some embodiments, region 20 may have included corrosion or other material damage which required to be removed prior to the addition of repair material. The removal of such damage may be performed using machining, grinding or other material removal process in order to prepare region 20 for the addition of repair material 22. In some embodiments, a surface of region 20 to which repair material 22 may be added may be cleaned using stainless steel wool and/or a stainless steel brush.

Once region 20 has been prepared, system 10 may be used to add repair material 22 to region 20. The addition of repair material 22 may be performed by the deposition of weld beads 24 in an overlapping manner in order to cover a surface of region 20. For example, weld beads 24 may be deposited in a manner analogous to surface cladding. The number of overlapping weld beads 24 may be a function of the size of the surface area to be cladded by repair material 22. For the purpose of controlling the movement of welding torch 16, a centerline of each adjacent weld bead 24 may be spaced apart by a suitable step-over distance SO. Each layer or pass 26 of one or more weld beads 24 may have a layer thickness H. It is understood that the step-over distance SO and the thickness H of each pass 26 may vary based on the process parameters used by welding system 10.

FIG. 1 shows an end-on view of weld beads 24 so that the direction of relative travel between welding torch 16 and casting 12 in FIG. 1 is perpendicular to the page. It is understood that the number of passes 26 required may depend on an overall height to be achieved by the repair material 22 above the surface of region 20 and may also depend on thickness H of each pass 26. For example, the height to be built-up using repair material 22 may depend on the extent of (e.g., corrosion) damage to casting 12, the amount of damaged material removed from casting 12 prior to repair and consequently on the amount of repair material 22 required to restore the geometry of casting 12. In some embodiments, the relative movement between welding torch 16 and casting 12 may comprise an oscillatory component (e.g., weaving pattern W) transverse to a general direction G of travel in order to produce weave beads 24. In some embodiments, the relative movement between welding torch 16 and casting 12 may be configured to produce stringer beads 24.

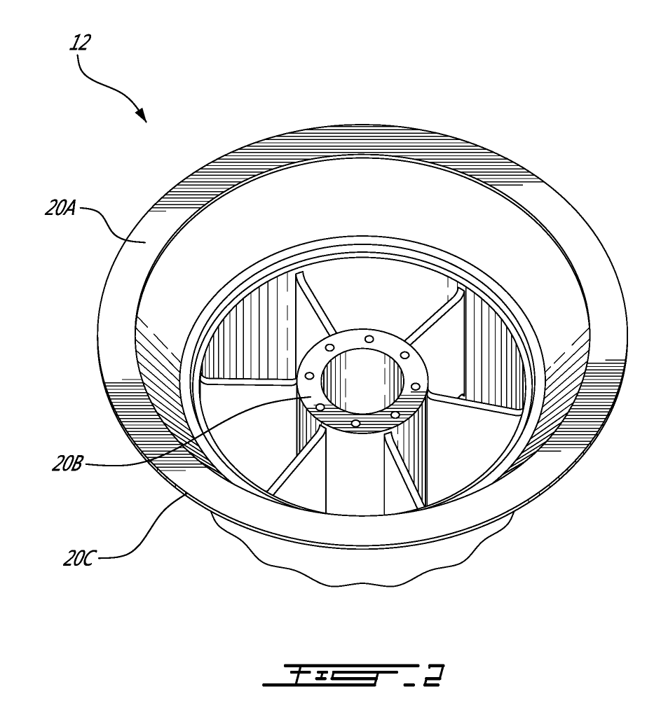

FIG. 2 is a perspective view of part of an exemplary magnesium casting 12 to be repaired. As mentioned above, casting 12 can be an air inlet case of a gas turbine engine. Casting 12 can be made from a magnesium-based cast material such as AMS 4439 magnesium alloy where wire 18 of compatible or substantially identical composition may be used as repair material 22. Casting 12 may comprise one or more regions 20A, 20B, 20C to be repaired using welding system 10. First region 20A may comprise a larger annular mating surface (e.g., flange) for mating with an adjacent component of the gas turbine engine. Second region 20B may comprise a smaller annular mating surface for mating with the same or other adjacent component of the gas turbine engine. Third region 20C may comprise an outer edge of first region 20A. First and third regions 20A, 20C are shown as having been prepared for the addition of repair material 22 using welding system 10 where damaged material has been removed from regions 20A and 20C using machining or grinding for example in order to provide a relatively clean and smooth surface on which to add repair material 22. Conversely, second region 20B is shown as not having yet been prepared for the addition of repair material 22. It is understood that second region 20B would be prepared in a manner similar to first region 20A prior to the addition of repair material 22.

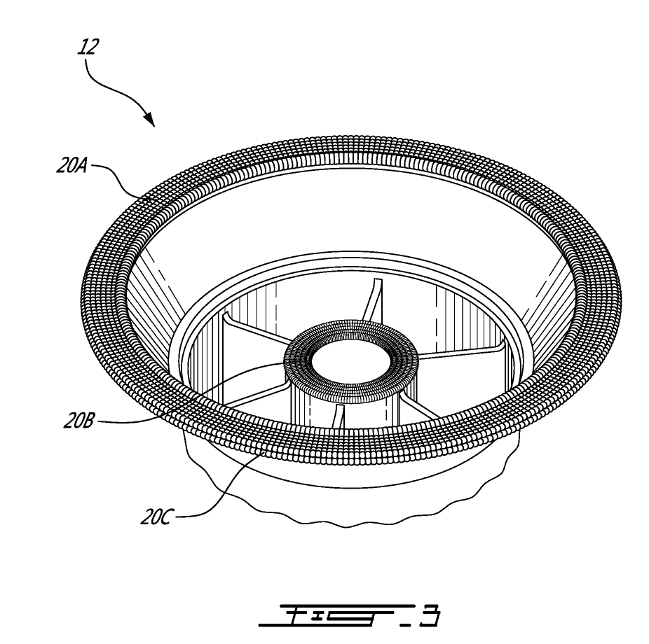

FIG. 3 is perspective view of part of the magnesium casting 12 of FIG. 2 after the addition of repair material 22 to regions 20A, 20B and 20C using welding system 10. As explained above in relation to FIG. 1, each region 20A, 20B, 20C may comprise one or more passes 26 of one or more (e.g., overlapping) weld beads 24 in order to build-up the desired amount of repair material 22. In some embodiments, the amount of repair material added to regions 20A, 20B, 20C may exceed that required to restore the geometry of casting 12 in order to provide a machining/grinding allowance for subsequently finishing regions 20A, 20B, 20C to the desired final dimensions and surface finish. In some situations, the dimensional accuracy and surface finish of repair material 22 in the as-deposited state may be acceptable so that no subsequent finishing operation is required. However, in some situations where repaired region 20 is a mating surface for example, it may be required to perform one or more finishing operations on the added repair material 22 in order to provide acceptable dimensional accuracy and surface finish.

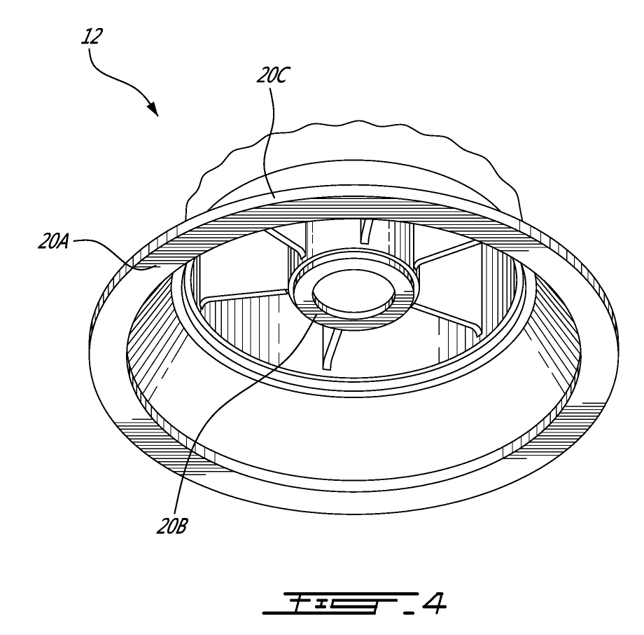

FIG. 4 is perspective view of part of magnesium casting 12 of FIG. 2 after finishing repaired regions 20A, 20B, 20C. In this situation, the amount of repair material 22 added to regions 20A, 20B, 20C was in excess of that required in order to provide a finishing allowance to allow for a subsequent finishing operation to produce an acceptable dimensional accuracy and surface finish of regions 20A, 20B, 20C. Such finishing operation may include machining, grinding and/or any other suitable material removal process for restoring region 20 of casting 12 to a condition suitable for continued usage so that the useful life of casting 12 can be extended instead of discarding casting 12 and replacing it with a new casting.

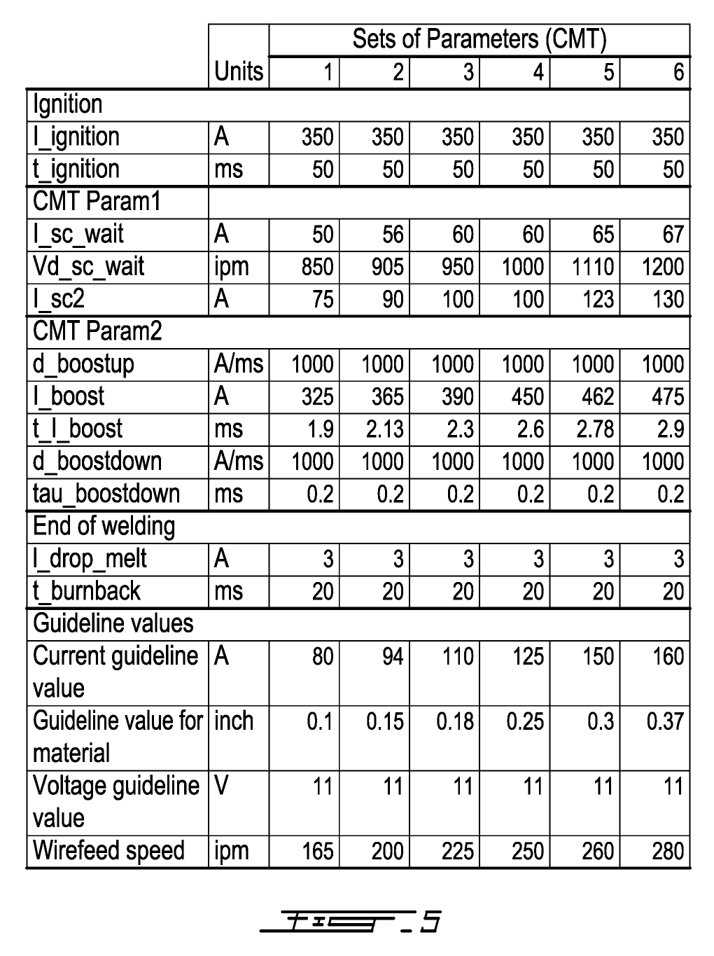

FIG. 5 is a table of exemplary process parameters used for repairing the exemplary casting 12 of FIG. 2 made of AMS 4439 magnesium alloy using CMT welding. Wire made of AMS 4439 (ZE41A) and having a diameter of about 0.063 inch (1.6 mm) was used. The process parameters of FIG. 5 were used on a TransPuls Synergic Advance 4000 CMT welding system sold under the trade name “FRONIUS”. The resistance of the welding circuit was 12.4 μOhms and the inductance of the welding circuit was 9 μH. Welding torch 16 used was a ROBACTA 5000 22° sold under the trade name “FRONIUS”.

The tip of welding torch 16 was maintained at a stand-off distance D of about 0.472 in (12 mm) from the workpiece (casting 12) during the repair process (see FIG. 1) using CMT. The tilt angle α (see FIG. 1) of welding torch 16 relative to a normal of a surface of region 20 was maintained at about 12 degrees during the addition of repair material 22. The material thickness of region 20A was about 0.28 inch prior to the addition of repair material 22. The diameter of region 20C was about 14.28 inch. The shielding gas used was only argon at a volumetric flow rate of 40 cubic feet per hour.

In reference to FIG. 5, a plurality of (e.g., six) sets of process parameters were determined for adding repair material to casting 12 using CMT welding. Different sets of parameters can be used in different situations and different sets of parameters can be used at different times during the repair of a single region of casting 12 (e.g., between passes). For example, the selection of different sets of parameters can be used to vary the parameters between consecutive passes 26 in order to reduce a heat input rate into casting 12. For example, the filler wire feed speed can impact the amperage. Reducing or increasing the filler wire feed speed can be used to manage the heat input into casting 12 (e.g., the lower the wire feed speed, the lower the amperage and hence the lower the heat input into the part). Each set of parameters listed in FIG. 5 can be associated with a particular filler wire feed speed. One skilled in the relevant arts will be familiar with the nature of the parameters listed in the table of FIG. 5. Nevertheless, a brief description of each parameter and its associated units are provided below for reference.

Parameter “I_ignition” (Amperes) is a current for preheating an energy reservoir for stickout. Parameter “t_ignition” (miliseconds) is a time duration of the preheating energy/current for stickout. “CMT Param1” represents the process of dipping the filler wire in the melted pool from an arc phase to a short circuit. Parameter “I_sc_wait” (Amperes) is a current used for dipping of the filler wire during the short circuit. Parameter “Vd_sc_wait” (inch per minute) is a filler wire feed speed for the filler wire dipping during the short circuit. Parameter “I_sc2” (Amperes) is a current during an arc re-ignition step. “CMT Param2” represents a short circuit free moment that includes a boost phase and an arc phase. Parameter “d_boostup” (Amperes/millisecond) is representative of energy input during the boost phase. Parameter “I_boost” (Amperes) is a current used during the boost phase. Parameter “t_I_boost” (milliseconds) is a time duration for the boost phase. Parameter “d_boostdown” (Amperes/millisecond) is used for a time high limit management of an arc reduction phase. Parameter “tau_boostdown” (milliseconds) is used for a time lower limit management of the arc reduction phase. “End of welding” represents a build-up of a ball at the filler wire end and preparing for a restart. Parameter “I_drop_melt” (Amperes) is a current used at the end of the process. Parameter “t_burnback” (miliseconds) is a time duration representing a powerless filler wire retracting period.

Guideline values are representative/summary values serving as a guide to an operator of welding system 10 as to which set of parameters is being used. The guideline values may also assist an operator of welding system 10 with the selection of a suitable set of parameters for a specific repair situation. One or more of the guideline values may be displayed on the remote control unit. “Current guideline value” may be a representative amperage associated with the set of parameters. “Guideline value for material” may be representative of a material thickness of a region of casting 12 to be repaired. “Voltage guideline value” may be representative of a reference voltage. The wire feed speed (inch per minute) may be a linear feed rate of welding filler wire 18 representing a consumption rate of welding filler wire 18 during the CMT transfer process associated with each set of parameters.

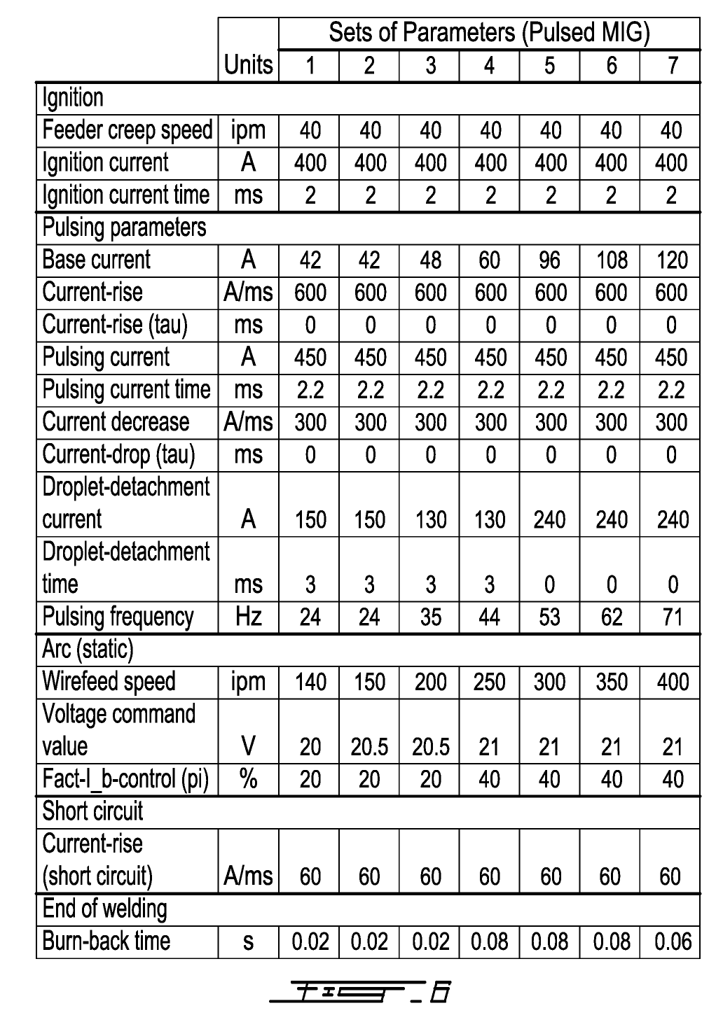

FIG. 6 is a table of exemplary process parameters used for repairing the exemplary casting 12 of FIG. 2 made of AMS 4439 magnesium alloy using pulsed MIG welding. Wire made of AMS 4439 (ZE41A) and having a diameter of about 0.063 inch (1.6 mm) was used. The process parameters of FIG. 6 were also used on the same welding system 10 (e.g., TransPuls Synergic Advance 4000 CMT welding system sold under the trade name “FRONIUS”) as described above. The tip of welding torch 16 was maintained at a stand-off distance D of about 0.59 in (15 mm) from the workpiece (casting 12) during the repair process (see FIG. 1) using pulsed MIG welding. The tilt angle α (see FIG. 1) of welding torch 16 relative to a normal of a surface of region 20 was maintained at about 12 degrees during the addition of repair material 22. The shielding gas used was only argon at a volumetric flow rate of 40 cubic feet per hour.

In reference to FIG. 6, a plurality of (e.g., seven) sets of process parameters were determined for adding repair material to casting 12 using pulsed welding. As mentioned above, the CMT and pulsed MIG welding processes may be conducted with the same welding system 10 at different times to add repair material 22 to different parts of casting 12. In some regions (e.g., regions 20A and 20C) of casting 12, repair material 22 may be added using CMT welding only. However, in other regions (e.g., 20B), the use of CMT may be combined with the use of pulsed MIG welding in order to complete the addition of repair material 22 in that particular region. For example, in order to obtain a suitable penetration and weld quality, it might be desirable to deposit one or more initial passes 26 or beads 24 (i.e., partial pass) of repair material 22 using pulsed MIG welding (higher heat input rate) and then switch to CMT welding (lower heat input rate) for the addition of the subsequent passes 26 or beads 24 in the same general region of casting 12. For example, it could be desirable to use pulsed MIG welding to add one or more beads 24 of repair material 22 at or near a radially outer edge of region 20B in order to achieve desirable properties of the repair material 22 and then switch to CMT to add the remainder of the required repair material 22. The selection of pulsed MIG or CMT may depend on the surface quality (e.g., surface finish, porosity), geometry and/or temperature of the region of casting 12 that is being repaired. In some situations, an initial deposition of some repair material 22 using pulsed MIG welding may cause the temperature of the particular region of casting 12 to increase to a temperature that is suitable for switching to CMT welding for the addition of the remainder of repair material 22 in that region.

Similar to the above description relating to CMT, different sets of parameters for pulsed MIG welding can be used in different situations and different sets of parameters can be used at different times during the repair of a single region of casting 12 (e.g., between passes). For example, the selection of different sets of parameters can be used to vary the pulsed MIG parameters between consecutive passes 26 in order to reduce a heat input rate into casting 12. Each set of parameters listed in FIG. 6 can be associated with a particular filler wire feed speed (inch/min). One skilled in the relevant arts will be familiar with the nature of the parameters listed in the table of FIG. 6. Nevertheless, a brief description of each parameter and its associated units are provided below for reference.

Parameter “Feeder creep speed” is a wire feeder speed at ignition. Parameter “Ignition Current” (Amperes) is a current for preheating an energy reservoir for stickout. Parameter “Ignition current time” (miliseconds) is a time duration of the preheating energy/current for stickout. “Pulsing parameters” represents low to high peak current modulation settings. Parameter “Base current” (Amperes) is a minimum current that maintains the welding arc between pulses. Parameter “Current rise” (Amperes/millisecond) is a linear speed of current increase. Parameter “Current rise (tau)” (miliseconds) is a time duration of a curved region of current increase in the pulse amplitude profile. Parameter “Pulsing current” (Amperes) is a maximum current value during pulsation. Parameter “Pulsing current time” (miliseconds) is a time duration at peak current value. Parameter “Current decrease” (Amperes/millisecond) is current drop rate and may be referred to as a root parameter setting. Parameter “Current drop (tau)” (miliseconds) is a time duration of a curved region of current decrease in the pulse amplitude profile. Parameter “Droplet-detachment current” (Amperes) is a current that is effective in decreasing the step edge of the pulse to provide an appropriate droplet detachment. Parameter “Droplet-detachment time” (miliseconds) is a time duration for droplet detachment. Parameter “Pulsing frequency” (Hz) is a frequency of the pulsation rate. “Arc static” represents the wire feed speed control stability. The wire feed speed (inch per minute) may be a linear feed rate of welding filler wire 18 representing a consumption rate of welding filler wire 18 during the pulsed MIG welding process associated with each set of parameters. Parameter “Voltage command value” (volts) is a voltage that is set at a constant value for the duration of the process. Parameter “Fact-I_b-control (pi)” (%) represents an effect of arc length correction percent on the base current and can be between 0% and 50%. “Short circuit” represents the filler wire being in contact with the substrate. Parameter “Current rise (short circuit)” (Amperes/millisecond) defines how the current is ramped up in the event of a short circuit. “End of welding” represents the end of the welding sequence. Parameter “Burn-back time” (miliseconds) is a time duration for filler metal retraction.

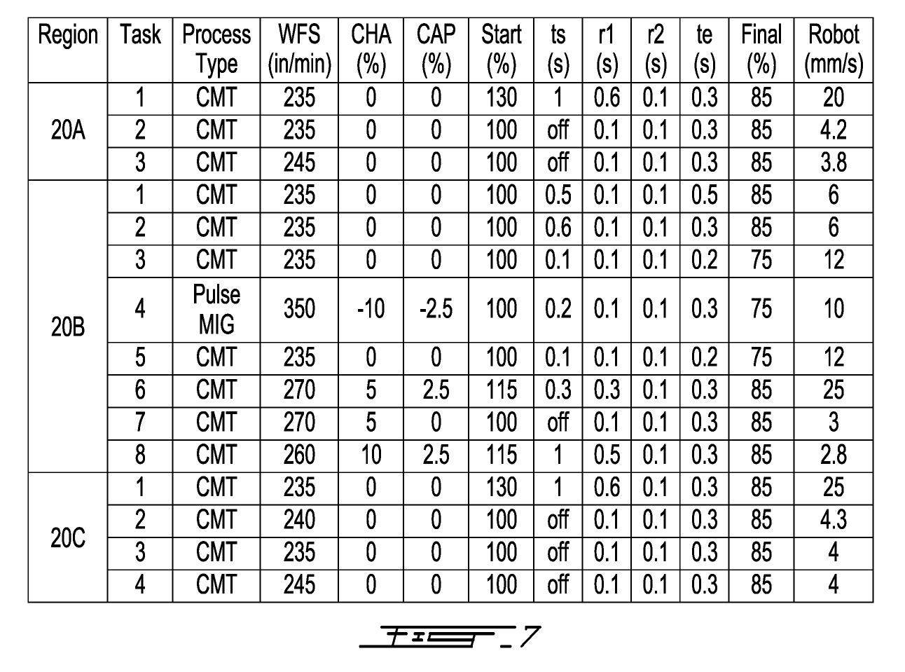

FIG. 7 is a table of exemplary process parameters for adding repair material to regions 20A-20C of casting 12 using CMT welding and pulsed MIG welding. Each task is associated with a particular set of parameters from FIG. 5 or FIG. 6 selected based on the corresponding wire feed speed (WFS) and process type (i.e., CMT or pulsed MIG) indicated in FIG. 7. In some situations, at the beginning of the repair procedure when casting 12 (the substrate) is relatively cool, a set of parameters producing a higher heat input may be used. As the repair procedure progresses, casting 12 may get warmer and the welding efficiency may increase. Therefore, the set of parameters may be changed to one that has a lower heat input as the procedure progresses (e.g., for subsequent passes). The parameters of FIG. 7 were specified in welding system 10 via the remote control unit “RCU 5000” also sold under the trade name “FRONIUS”.

FIG. 7 shows that, in regions 20A and 20C of casting 12, repair material 22 was added to casting 12 using only CMT. However, in region 20B, a combination of CMT and pulsed MIG welding was used. For a specific portion of region 20B near and at a radially-outer edge of region 20B it was desirable to use pulsed MIG to obtain a suitable weld penetration and quality prior to switching over to CMT for adding subsequent layers of repair material 22. It is understood that the selection of suitable parameters may vary based on the specific application and the set of parameters herein are provided as examples only. The set of parameters illustrated in FIGS. 5 and 6 may also be referred as “synergic lines” for use with a “TransPuls Synergic 4000” welding system 10 sold under the trade name “FRONIUS”.

One skilled in the relevant arts will be familiar with the nature of the parameters listed in the table of FIG. 7. Nevertheless, a brief description of each parameter and its associated units is provided below for reference.

Parameter “WFS” (inch per minute) is a linear feed rate of welding filler wire 18 (repair material) representing a consumption rate of welding filler wire 18 during CMT welding. Parameter “CHA” (%) represents an arc length correction. Parameter “CAP” (%) represents a direct-current (DC) dynamic correction. Parameter “Start” (%) represents a starting current. Parameter “ts” (s) represents a time duration for the starting current. Parameter “r1” (s) represents a first slope known as “slope 1”. Parameter “r2” (s) represents a second slope known as “slope 2”. Parameter “te” (s) represents a time duration for a final current. Parameter “final” (%) represents the final current. Parameter “Robot” (mm/sec) is a linear travel speed of welding torch 16 relative to region 20 of casting 12 during CMT welding.

For the CMT welding procedure of region 20A, the representative CMT welding parameters were as follows: process time: 265 seconds; average voltage: 11.2 volts; average current: 117 amperes and the quantity of repair material added: 99.7 grams (0.22 lb).

For the CMT welding procedure of region 20B, the representative CMT welding parameters were as follows: process time: 1738 seconds; average voltage: 11.0 volts; average current: 118 amperes and the quantity of repair material added: 653.5 grams (1.44 lb).

The above description is meant to be exemplary only, and one skilled in the relevant arts will recognize that changes may be made to the embodiments described without departing from the scope of the invention disclosed. The present disclosure may be embodied in other specific forms without departing from the subject matter of the claims. The present disclosure is intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

What is claimed is:

1. A method for repairing a cast component made of a magnesium-based material, the method comprising:
receiving the cast component made of the magnesium-based material; and
adding repair material to the cast component using cold metal transfer (CMT) welding.

2. The method as defined in claim 1, wherein the magnesium-based material of the cast component is AMS 4439 magnesium alloy.

3. The method as defined in claim 1, wherein the repair material is AMS 4439 magnesium alloy.

4. The method as defined in claim 1, wherein using CMT welding comprises using a wire made of AMS 4439 magnesium alloy as a source of repair material.

5. The method as defined in claim 1, wherein adding repair material to the cast component comprises making a plurality of passes on the cast component and using different CMT welding process parameters for two consecutive passes.

6. The method as defined in claim 1, wherein adding repair material to the cast component comprises making a plurality of passes on the cast component and using a different CMT welding process parameter for each pass.

7. The method as defined in claim 1, wherein adding repair material to the cast component comprises making a plurality of passes on the cast component and reducing a heat input rate into the cast component by CMT welding from one pass to a subsequent pass.

8. The method as defined in claim 1, comprising adding repair material to a region of the cast component using CMT welding and using more than two different CMT welding process parameters while adding repair material to the region.

9. The method as defined in claim 8, wherein the region is annular.

10. The method as defined in claim 1, wherein the cast component is an air inlet case of a gas turbine engine.

11. The method as defined in claim 1, comprising removing material from a region of the cast component before adding repair material to the same region of the cast component.

12. The method as defined in claim 11, comprising removing repair material from the region to finish the region after adding the repair material to the region.

13. The method as defined in claim 12, wherein the repair material is AMS 4439 magnesium alloy.

14. The method as defined in claim 13, wherein using CMT welding comprises using a wire made of AMS 4439 magnesium alloy as a source of repair material.

15. The method as defined in claim 14, comprising adding repair material to the cast component using pulsed metal inert gas (MIG) welding.

16. The method as defined in claim 15, wherein adding repair material to the cast component comprises making a plurality of passes in the region of the cast component and using different CMT welding process parameters for two consecutive passes.

17. The method as defined in claim 16, wherein the region includes a mating surface for interfacing with another component.

18. The method as defined in claim 17, wherein the cast component is an air inlet case of a gas turbine engine.

19. The method as defined in claim 1, comprising using an oscillatory movement between a welding torch and the cast component transverse to a general relative direction of travel to produce a weaving pattern during the addition of repair material.

20. The method as defined in claim 1, comprising adding repair material to the cast component using pulsed MIG welding and then adding repair material to the cast component using CMT welding.
